(19) United States
(12) Patent Application Publication
(10) Pub. No.: US 2024/0092373 A1
(43) Pub. Date: Mar. 21, 2024

(54) STEERING CONTROL APPARATUS AND METHOD OF CONTROLLING SAME

(71) Applicant: HYUNDAI MOBIS CO., LTD., Seoul (KR)

(72) Inventor: Tae Hong KIM, Yongin-si (KR)

(73) Assignee: HYUNDAI MOBIS CO., LTD., Seoul (KR)

(21) Appl. No.: 18/223,637

(22) Filed: Jul. 19, 2023

(30) Foreign Application Priority Data
Sep. 20, 2022 (KR) 10-2022-0118624

(51) Int. Cl. B60W 50/02; B60W 60/00; B62D 5/04; B62D 15/02

(52) U.S. Cl. CPC B60W 50/0225; B60W 50/0205; B60W 60/001; B62D 5/0481; B62D 15/0215; B62D 15/0235

(57) ABSTRACT

A vehicle steering control apparatus and a method of controlling the vehicle steering control apparatus. When a rotational movement of a steering wheel is detected during autonomous traveling, a steering apparatus is controlled by changing a reference steering angle signal for controlling the steering apparatus, while a vehicle is kept traveling in an autonomous traveling mode for a predetermined time without deactivating the autonomous traveling mode. Thus, a change due to the rotational movement of the steering wheel is compensated for, the instability in autonomous traveling caused by switching between traveling modes is eliminated, and the occurrence of a traffic accident due to deviation from the vehicle's intended traveling course and loss of control is prevented. As a result, the effect of improving the stability in the autonomous traveling can be achieved, ensuring that the vehicle stays on the intended traveling course.

### CROSS-REFERENCE TO RELATED APPLICATION

This application claims priority from and the benefit of Korean Patent Application No. 10-2022-0118624, filed on Sep. 20, 2022, which is hereby incorporated by reference for all purposes as if set forth herein.

### BACKGROUND

### Field

Exemplary embodiments of the present disclosure relate to a vehicle steering control apparatus and a method of controlling the vehicle steering control apparatus and, more particularly, to a vehicle steering control apparatus capable of compensating for a change in a traveling direction due to a rotational movement of a steering wheel during autonomous traveling and keeping a vehicle traveling autonomously, and a method of controlling the vehicle steering control apparatus.

### Discussion of the Background

With a driver's operation of a steering wheel, a motor-driven power steering (MDPS) apparatus operates to change a direction of a wheel, thereby changing a traveling direction of a vehicle.

The MDPS apparatus assists the driver in more easily operating the steering wheel, thereby controlling the traveling direction of the vehicle.

In recent years, there has been a trend towards applying autonomous traveling technologies that detect an obstacle without the driver's involvement and enable the vehicle to travel to a destination by controlling a traveling direction of the vehicle.

Accordingly, the vehicle is equipped with a camera and a plurality of sensors and is configured to recognize an obstacle in a surrounding environment, to detect a road situation, and to control the traveling direction according to the obstacle in the surrounding environment and the road situation.

The autonomous traveling technologies are categorized into five levels. In the first level, the driver is assisted in driving the vehicle. In the second level that is higher than the first level of simply assisting the driver, automation is applied partially to assist the driver during vehicle traveling. In the third level, the vehicle travels autonomously in a conditional environment. That is, the vehicle travels autonomously in a specific road situation, such as an expressway, and the driver is involved when a risky situation occurs. In the fourth level, the vehicle travels autonomously on a normal road. In the fifth level, the vehicle travels fully autonomously without the driver's involvement.

The second level of the autonomous traveling technology, where the automation is partially applied and the third level, where the vehicle travels autonomously in a conditional environment have applied to the vehicle. In addition, the fourth level or the fifth level of the autonomous traveling technology has applied to an unmanned shuttle bus and the like that does not have a driver seat.

A steering apparatus plays an important role because the traveling direction of this autonomous traveling vehicle has to be controlled according to the detected obstacle and the road situation.

The related art of the present disclosure is disclosed in Korean Patent Application Publication No. 10-2022-0090233 entitled “A steering system for autonomous vehicles.”

The driver is involved in vehicle driving when a risky situation is detected or an abnormality occurs during the vehicle traveling.

When the driver operates the steering wheel in an autonomous traveling mode, the autonomous traveling mode is deactivated, and the vehicle switches to the driver-involved vehicle traveling. However, when the steering wheel is abruptly operated, a target steering angle cannot be reflected, making it difficult to control the traveling direction. As a result, there is a likelihood that the vehicle will deviate from its intended traveling course, leading to an occurrence of a traffic accident.

When the autonomous traveling mode is deactivated in a situation where the driver loses consciousness during the vehicle traveling or where the steering wheel is rotationally moved due to an external shock, the driver cannot deal with this situation, making it impossible to control the autonomous traveling. Thus, traffic accidents may occur.

Accordingly, there is a need to determine whether or not the driver is actually involved in the autonomous traveling while the vehicle is kept traveling autonomously and to deactivate the autonomous traveling mode step by step according to the result of the determination, instead of immediately deactivating the autonomous traveling mode when the steering wheel is rotationally moved during the autonomous traveling.

For this reason, there is a need to correct the traveling direction according to the rotational movement of the steering wheel during the autonomous traveling and to keep the vehicle traveling autonomously.

### Patent Document

Korean Patent Application Publication No. 10-2022-0090233

### SUMMARY

Various embodiments are directed to a vehicle steering control apparatus capable of keeping a vehicle traveling autonomously for a predetermined time without deactivating an autonomous traveling mode when a rotational movement of a steering wheel is detected during autonomous traveling and of compensating for a change in a traveling direction due to the rotational movement of the steering wheel, thereby keep the vehicle traveling stably, and a method of controlling the vehicle steering control apparatus.

In an embodiment of the present disclosure, a vehicle steering control apparatus includes: a steering apparatus configured to control a traveling direction of a vehicle; an autonomous traveling controller configured to compute a commanded steering angle for controlling the traveling direction of the vehicle in an autonomous traveling mode; a position controller configured to control the steering apparatus in response to the commanded steering angle; a motor-angle sensor installed in the steering apparatus and configured to measure a motor angle; a steering angle sensor installed in a steering wheel and configured to measure a steering angle that corresponds to a rotational movement of the steering wheel; and a processor configured to set a reference steering angle signal in such a manner as to control the steering apparatus on the basis of one of a first steering angle signal computed from the motor angle and a second steering angle of the steering angle sensor, in a manner that corresponds to an autonomous traveling mode of the vehicle, to generate a feedback signal on a control error on the basis of the reference steering angle signal, and to apply the generated feedback signal to the autonomous traveling controller, wherein the processor changes the reference steering angle signal to the second steering angle when the rotational movement of the steering wheel is detected in the autonomous traveling mode.

In an embodiment of the present disclosure, in the vehicle steering control apparatus, when the rotational movement of the steering wheel is detected in the autonomous traveling mode, the processor may keep the vehicle traveling in the autonomous traveling mode for a predetermined time and may compensate for the rotational movement of the steering wheel through the feedback signal.

In an embodiment of the present disclosure, in the vehicle steering control apparatus, when a time taken to maintain a column torque due to the rotational movement of the steering wheel exceeds a preset time and a magnitude of the commanded steering angle that changes due to the rotational movement of the steering wheel exceeds a preset value, the processor may change the reference steering angle signal to the second steering angle signal.

In an embodiment of the present disclosure, in the vehicle steering control apparatus, the processor may remove a resonance point of the column torque by filtering the column torque through one of a notch filter, a band-stop filter, and a lead-lag filter.

In an embodiment of the present disclosure, in the vehicle steering control apparatus, when a time taken to maintain a column torque due to the rotational movement of the steering wheel reaches or falls short of a preset time, or when a magnitude of the commanded steering angle that changes due to the rotational movement of the steering wheel reaches or falls short of a preset value, the processor may maintain the reference steering angle signal as the first steering angle signal.

In an embodiment of the present disclosure, in the vehicle steering control apparatus, the processor may change the reference steering angle signal by adjusting a reflection ratio step by step within a designated time.

In an embodiment of the present disclosure, in the vehicle steering control apparatus, when the rotational movement of the steering wheel is detected in the autonomous traveling mode, the processor may keep the vehicle traveling in the autonomous traveling mode by changing a condition for deactivating the autonomous traveling mode.

In an embodiment of the present disclosure, in the vehicle steering control apparatus, either when the rotational movement of the steering wheel satisfies a changed condition or when the steering wheel continues to be rotationally moved by a driver's steering, the processor may deactivate the autonomous traveling mode and may switch to a driver steering mode.

In an embodiment of the present disclosure, a method of controlling a vehicle steering control apparatus includes: setting, by a processor, a reference steering angle signal in such a manner that a steering apparatus is controlled on the basis of one of a first steering angle signal computed from a motor angle of a motor-angle sensor and a second steering angle signal of a steering angle sensor, in a manner that corresponds to an autonomous traveling mode of a vehicle; computing, by an autonomous traveling controller, a commanded steering angle for controlling a traveling direction of the vehicle and controlling, by a position controller, the steering apparatus in a manner that corresponds to the commanded steering angle, in the autonomous traveling mode; generating, by the processor, a feedback signal on a control error on the basis of the first steering angle signal and applying, by the processor, the generated feedback signal to the position controller and the autonomous traveling controller; changing, by the processor, the reference steering angle signal to the second steering angle signal in response to a rotational movement of a steering wheel being detected in the autonomous traveling mode; and generating, by the processor, the feedback signal on the basis of the second steering angle signal and applying the generated feedback signal to the position controller and the autonomous traveling controller.

In an embodiment of the present disclosure, the method may further include, in response to the rotational movement of the steering wheel being detected in the autonomous traveling mode, keeping, by the processor, the vehicle traveling in the autonomous traveling mode, and compensating for, by the processor, the rotational movement of the steering wheel through the feedback signal.

In an embodiment of the present disclosure, in the method, the changing of the reference steering angle signal to the second steering angle signal may include: counting, by the processor, a time taken to maintain column torque due to the rotational movement of the steering wheel and comparing the counted time taken to maintain the column torque with a preset time; comparing, by the processor, a magnitude of the commanded steering angle that changes due to the rotational movement of the steering wheel with a preset value; and changing, by the processor, the reference steering angle signal to the second steering angle signal in response to the time taken to maintain the column torque exceeding the preset time and the magnitude of the commanded steering angle exceeds the preset value.

In an embodiment of the present disclosure, in the method, the changing of the reference steering angle signal to the second steering angle signal may further include removing, by the processor, a resonance point of the column torque by filtering the column torque through one of a notch filter, a band-stop filter, and a lead-drag filter.

In an embodiment of the present disclosure, the method may further include maintaining, by the processor, the reference steering angle signal as the first steering angle signal in response to a time taken to maintain column torque due to the rotational movement of the steering wheel reaching or falling short of a preset time or in response to a magnitude of the commanded steering angle that changes due to the rotational movement of the steering wheel reaching or falling short of a preset value, in response to the rotational movement of the steering wheel being detected in the autonomous mode.

In an embodiment of the present disclosure, in the method, the changing of the reference steering angle signal to the second steering angle signal including changing, by the processor, the reference steering angle signal from the first steering angle signal to the second steering angle signal by adjusting a reflection ratio step by step within a designated time.

In an embodiment of the present disclosure, the method may further include: keeping, by the processor, the vehicle traveling in the autonomous traveling mode by changing a condition for deactivating the autonomous traveling mode, in response to the rotational movement of the steering wheel being detected in the autonomous traveling mode; and deactivating, by the processor, the autonomous traveling mode and switching to a driver steering mode either in response to the rotational movement of the steering wheel satisfying a changed condition or in response to the steering wheel continuing to be rotationally moved by a driver's steering.

According to an aspect of the present disclosure, the vehicle steering control apparatus and the method of controlling the vehicle steering control apparatus are capable of providing the effect of compensating for a change in a traveling direction of a vehicle due to the rotational movement of the steering wheel detected during autonomous traveling. This capability helps prevent the vehicle from its intended traveling course. Thus, the effect of improving the stability in the vehicle traveling can be achieved.

According to another aspect of the present disclosure, the vehicle steering control apparatus and the method of controlling the vehicle steering control apparatus are capable of keeping the vehicle traveling autonomously without deactivating the autonomous traveling mode, in response to the rotational movement of the steering wheel. This capability helps eliminate the instability in autonomous traveling caused by switching between traveling modes, thereby preventing traffic accidents resulting from deviations from the vehicle's intended traveling course and loss of control.

### BRIEF DESCRIPTION OF THE DRAWINGS

FIG. 1 is a block diagram illustrating a configuration of a vehicle steering control apparatus according to a first embodiment of the present disclosure.

FIG. 2 is a flowchart for signal transmission that results when the vehicle steering control apparatus according to the first embodiment of the present disclosure performs steering control.

FIG. 3 is a flowchart for signal transmission that results when the vehicle steering control apparatus according to the first embodiment of the present disclosure switches between control methods.

FIG. 4 is a block diagram illustrating a control configuration of the vehicle steering control apparatus according to the first embodiment of the present disclosure that switches between the control methods.

FIG. 5 is a flowchart illustrating a method of controlling the vehicle steering control apparatus according to a second embodiment of the present disclosure.

### DETAILED DESCRIPTION OF THE ILLUSTRATED EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

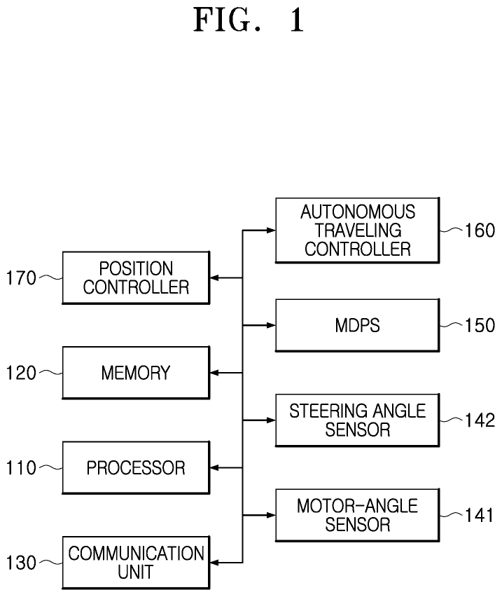

FIG. 1 is a block diagram illustrating a configuration of a vehicle steering control apparatus according to a first embodiment of the present disclosure.

As illustrated in FIG. 1, the vehicle steering control apparatus includes a position controller 170, an autonomous traveling controller 160, a motor-driven power steering (MDPS) apparatus 150, a steering angle sensor 142, a motor-angle sensor 141, a memory 120, a communication unit 130, and a processor 110.

The steering angle sensor 142 is provided in the steering wheel and measures a steering angle that varies with rotational operation of a steering wheel. A steering angular velocity is a rate of change of the steering angle with respect to time and may be computed by differentiating the steering angle.

The motor-angle sensor 141 measures a motor angle that varies as a result of the MDPS apparatus 150 driving a steering motor. The motor-angle sensor 141 provides a current computed steering angle that is obtained by measuring a rotational position of the steering motor.

In addition, the vehicle steering control apparatus may further include a torque sensor (not illustrated) and a vehicle speed sensor (not illustrated). The torque sensor is installed in the MDPS apparatus 150 including the steering wheel and measures a steering torque that varies as a result of operating the steering wheel. The vehicle speed sensor measures a speed of a vehicle (a vehicle speed).

The MDPS apparatus 150 performs steering by driving the steering motor (not illustrated) according to a target steering angle that is output from the position controller 170 through feedback control.

When the steering wheel is operated, the MDPS apparatus 150 provides a drive force that assists a driver in performing the operational operation of the steering wheel with reduced effort. The MDPS apparatus, which serves as an exemplification of a steering apparatus, is described. An electric power assisted steering (EPAS) apparatus or an electric power steering (EPS) apparatus may be used instead of the MDPS apparatus.

In an autonomous traveling mode, the autonomous traveling controller 160 computes a commanded steering angle for traveling to a destination, on the basis of images that are input from a plurality of sensors and a camera, and applies the computed commanded steering angle to the position controller 170.

In addition, the autonomous traveling controller 160 computes the commanded steering angle by compensating for an error resulting from positional control on the basis of a feedback signal.

When the autonomous traveling mode is deactivated and then in a driver steering mode, a driver operates the steering wheel, the autonomous traveling controller 160 computes the commanded steering angle that corresponds to the rotation of the steering wheel and applies the computed commanded angle to the position controller 170.

The position controller 170 receives the vehicle speed, the commanded steering angle, and the current steering angle, as inputs, and applies them to the MDPS apparatus 150.

The position controller 170 receives a signal that is fed back and performs positional correction. An error value increases when a friction force is high between a vehicle and a road surface, when an obstacle is present on the road surface, when steering is performed in a state where the vehicle travels at a normal speed and has high self-alignment capability, or when an occurrence of a lateral force due to wind causes actual steering control to achieve the target steering angle. For this reason, the target steering angle is computed by applying the error value.

The communication unit 130 transmits and receives data between components inside the vehicle. The communication unit 130 includes a communication driver for a controller area network (CAN) and transmits and receives internal data inside the vehicle.

In addition, the communication unit 130 may include a wired or wireless communication module and may communicate with a portable terminal or an external server.

For example, the communication unit 130 performs at least one of short-distance communication through Ethernet, WiFi, Bluetooth, and the like, mobile communication, and serial communication.

Stored in the memory 120 are data that are transmitted and received through the communication unit 130, data for steering control, and data that are generated during a process in which the processor 110 performs an arithmetic operation. Stored in the memory 120 are data obtained as a result of measurements by a plurality of sensors, for example, data on a voltage, electric current, a steering angle, a speed, and the like.

Stored in the memory 120 are data associated with at least one of a steering control algorithm, an autonomous traveling algorithm, an emergency driving algorithm, a traveling control algorithm, and an input and output algorithm.

Examples of the memory 120 include non-volatile memories, such as a random access memory (RAM), a ROM, an electrically erased programmable ROM (EEPROM), and storage units, such as a flash memory.

The processor 110 keeps the vehicle traveling in an autonomous traveling mode or deactivates the autonomous traveling mode on the basis of a rotational movement of the steering wheel while the vehicle travels in the autonomous traveling mode. When deactivating the autonomous traveling mode, the processor 110 switches to the driver steering mode.

When the rotational movement of the steering wheel reaches or exceeds a preset value, the processor 110 deactivates the autonomous traveling mode and switches to the driver steering mode.

The processor 110 generates a feedback signal on the basis of data, the commanded steering angle, and a column torque that are obtained from the motor-angle sensor 141 and the steering angle sensor 142 of the MDPS apparatus 150, and applies the generated feedback signal to the position controller 170 and the autonomous traveling controller 160.

In the autonomous traveling mode, the processor 110 generates the feedback signal on the basis of a steering angle signal and applies the generated feedback signal to the position controller 170 and the autonomous traveling controller 160.

In association with operation of the MDPS apparatus 150, the processor 110 receives a signal of the motor-angle sensor 141 installed in a motor and a signal of the steering angle sensor 142 installed in the steering wheel, as inputs. The processor 110 sets one of the received signals as a reference steering angle signal for controlling the MDPS apparatus 150 and generates a feedback signal. The processor 110 generates a final feedback signal related to a control error by selecting one of a motor position sensor (MPS) signal of the motor-angle sensor 141 and a steering angle sensor (SAS) signal of the steering angle sensor 142.

The processor 110 generates the final feedback signal on the basis of a steering angle signal of the motor-angle sensor 141 in the autonomous traveling mode and generates the final feedback signal on the basis of a steering angle signal of the steering angle sensor 142 in the driver steering mode.

The processor 110 may determine whether or not the driver operates the steering wheel, based on a signal value of the steering angle sensor 142, and may deactivate the autonomous traveling mode.

However, when the steering angle changes abruptly, that is, changes by a predetermined angle within a specific time, the processor 110 keeps the vehicle traveling in the autonomous traveling mode, but generates a final feedback signal on the basis of the steering angle signal of the motor-angle sensor 141 and thus compensates for the rotational movement of the steering wheel.

The processor 110 may be configured with at least one micro-processor.

The processor 110 controls the MDPS apparatus 150 by operating on the traveling control algorithm stored in the memory 120. The processor 110 may be a motor control unit (MCU).

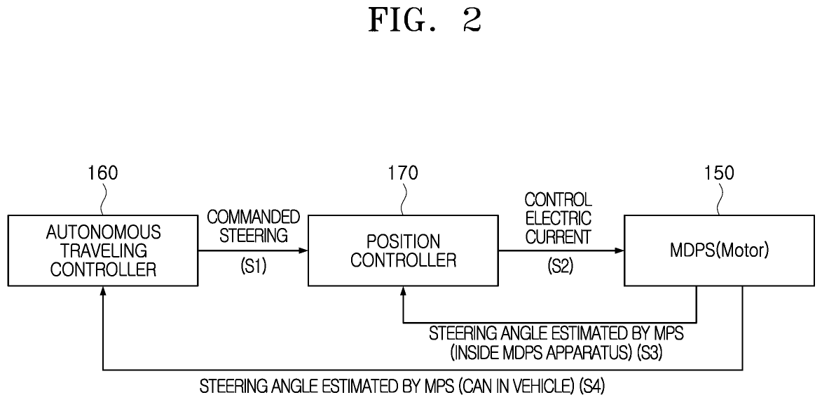

FIG. 2 is a flowchart for signal transmission that results when the vehicle steering control apparatus according to the first embodiment of the present disclosure performs steering control.

As illustrated in FIG. 2A, the autonomous traveling controller 160 computes the commanded steering angle and applies the computed commanded steering angle to the position controller 170 (S1).

The position controller 170 controls the steering motor by applying control electric current to the MDPS apparatus 150 in a manner that corresponds to the commanded steering angle (S2).

The position controller 170 generates a motor position steering angle signal (the MPS signal) by converting into a gear ratio the motor angle measured through an encoder or the motor-angle sensor 141 that is provided in a motor of the MDPS apparatus 150. Furthermore, the position controller 170 controls the MDPS apparatus 150 by receiving as the feedback signal the control error resulting from a motor position steering angle signal (S3).

The motor position steering angle (the MPS signal) serves as a respective control entity when the motor of the MDPS apparatus 150 controls a wheel of the vehicle in a manner that directs in the transverse direction. For this reason, the position controller 170 controls the MDPS apparatus 150 using the steering angle signal that varies with a motor position steering angle computed from a motor angle of the motor-angle sensor 141.

The autonomous traveling controller 160 receives feedback on the motor position steering angle signal computed from the motor angle of the motor-angle sensor 141 and applies the commanded steering angle to the position controller 170.

While the vehicle travels in the autonomous traveling mode, when the driver operates the steering wheel or when the steering wheel is rotationally moved due to an external shock, the rotational movement of the steering wheel may have an influence on autonomous traveling control. Particularly, there is a likelihood that the abrupt rotational movement of the steering wheel will cause the vehicle to deviate from its intended traveling course, resulting in a traffic accident.

While the vehicle travels in the autonomous traveling mode, when the steering wheel is rotationally moved, the processor 110 detects the rotational movement of the steering wheel and performs auxiliary control.

The processor 110 cannot determine the rotational movement of the steering wheel through the motor position steering angle signal of the motor-angle sensor 141. For this reason, instead of performing control that varies with the motor position steering angle signal, the processor 110 changes the reference steering angle signal on the basis of the steering angle signal of the steering angle sensor 142 of the steering wheel.”

The processor 110 determines the extent of the rotational movement of the steering wheel by changing the reference steering angle signal. In order to adjust the rotational movement of the steering wheel, the processor 110 performs compensation control by generating the feedback signal on the basis of the steering angle signal (the SAS signal) of the steering angle sensor 142.

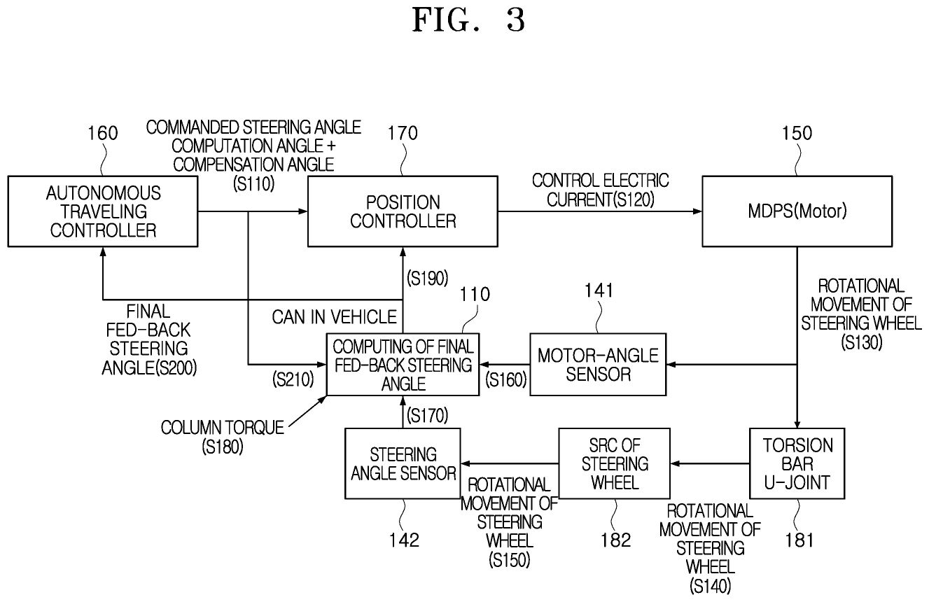

FIG. 3 is a flowchart for signal transmission that results when the vehicle steering control apparatus according to the first embodiment of the present disclosure switches between control methods.

As illustrated in FIG. 3, when the rotational movement of the steering wheel due to the operation of the steering wheel by the driver or the external shock is detected during autonomous traveling, the processor 110 performs the compensation control by generating the feedback signal on the basis of the steering angle signal of the steering angle sensor.

Particularly, when the steering wheel is rotationally moved as opposed to the driver's intention, the processor 110 performs the compensation control that deals with this rotational movement of the steering wheel, without deactivating the autonomous traveling mode, and then keeps the vehicle traveling autonomously.

For example, when the driver operates the steering wheel during normal autonomous traveling, there is a need to perform the autonomous traveling control without deactivating the autonomous traveling mode. That is, the position controller 170 detects an unintended rotational movement of the steering wheel and performs positional control by immediately receiving as feedback the steering angle signal of the steering angle sensor 142.

The processor 110 determines whether or not the driver operates the steering wheel, considering all these factors, and generates the feedback signal for the autonomous traveling control on the basis of the result of the determination.

The autonomous traveling controller 160 generates another commanded steering angle by applying a computation angle and the compensation angle to the commanded steering angle and applies the generated commanded steering angle to the position controller 170 (S110). The position controller 170 applies the control electric current to the MDPS apparatus 150 in a manner that corresponds to the commanded steering angle that results from the compensation control (S120).

During the autonomous traveling, the motor-angle sensor 141 detects the motor angle, and the processor 110 generates a motor position steering angle signal on the basis of the motor angle and feeds back the generated motor position steering angle signal (S160).

When the steering wheel is rotationally moved (S130), a torsion bar U-joint 181 is rotated (S140). When an SRC 182 of the steering wheel is rotated (S15), the steering angle sensor 142 detects the steering angle. The SRC 182 is a rotating entity that is provided in the steering wheel and transfers switch signals of an airbag, a vehicle horn, an audio remote controller and the like to an electronic control unit (ECU).

During the autonomous traveling, a value of the column torque converges to 0. When the commanded steering angle changes abruptly during the autonomous traveling, a torsion bar moves quickly in response. At this time, a pinion unit is abruptly twisted, and thus the column torque increases momentarily. In this case, although the driver does not operate the steering wheel, the column torque may increase.

The processor 110 receives and integrates data that are obtained by detection through CAN communication and switches from the positional control based on the motor position steering angle signal to the positional control based on the steering angle signal of the steering angle sensor 142. Then, the processor 110 applies the resulting final feedback to the position controller 170 and the autonomous traveling controller 160 (S190) (S200).

The processor 110 determines whether the steering wheel is involved in the driver's traveling control, on the basis of various signals, such as sensor signals. Furthermore, the processor 110 generates the final feedback signal using the steering angle signal of the steering angle sensor 142 and the column torque.

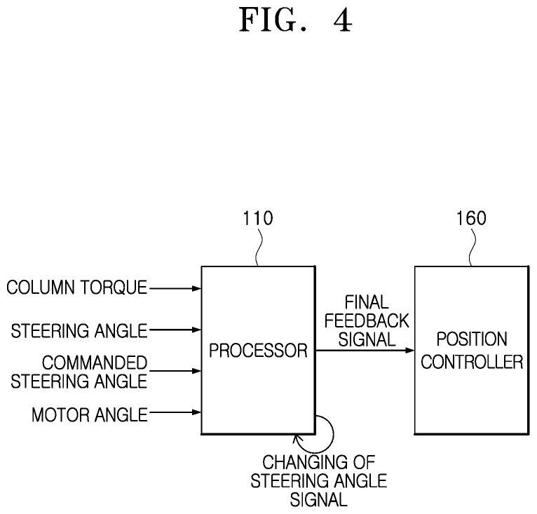

FIG. 4 is a block diagram illustrating a control configuration of the vehicle steering control apparatus according to the first embodiment of the present disclosure that switches between the control methods.

As illustrated in FIG. 4, the processor 110 receives the column torque, the steering angle signal of the steering angle sensor 142, the commanded steering angle of the autonomous traveling controller 160, and the motor angle of the motor-angle sensor 141, as inputs. Thus, the processor 110 generates the final feedback signal, depending on a traveling situation, and applies the generated final feedback signal to the position controller 170 and the autonomous traveling controller 160.

The processor 110 changes the reference steering angle signal on the basis of one of the motor position steering angle signal and the steering angle sensor 142 of the steering wheel.

The processor 110 generates the final feedback signal by changing the reference steering angle signal according to need and controls the MDPS apparatus 150 by applying the generated final feedback signal to the position controller 170.

In order to generate the final feedback signal, the processor 110 receives a column torque value and the commanded steering angle.

The column torque is determined by the torsion bar being twisted. As a result, although the driver does not hold on the steering wheel, the column torque may occur due to a bump on a surface, an external shock, or the like.

In order to remove a signal associated with the occurrence of the column torque, that is, in order to remove a torque output that occurs from a resonance point of the torsion bar, the processor 110 removes a resonance point of a torque signal using at least one of a notch filter, a band-stop filter, and a lead-lag filter.

In addition, based on the torque signal, the processor 110 determines whether or not the column torque value reaches or exceeds a predetermined value and determines the time for which the column torque value is maintained. Then, depending on the result of the determination, the processor 110 determines whether or not the driver operates the steering wheel.

An instantaneous rotational movement of the steering wheel does not have an influence on the autonomous traveling control. However, the processor 110 determines whether or not the compensation control is performed, depending on a magnitude of the instantaneous rotational movement.

When the driver temporarily operates the steering wheel, the processor 110 keeps the vehicle traveling autonomously.

When the steering wheel is rotationally moved to a large extent for a short time, the twisting of the torsion bar may increase a torque value due to inertia. For this reason, when a commanded angle velocity is high, the processor 110 increases a reference for determining the driver's operation of the rotational movement of the steering wheel.

When the rotational movement of the steering wheel reaches or exceeds a predetermined value for a preset time, the processor 110 deactivates the autonomous traveling and switches to the driver steering mode. However, when the reference for determining the driver's operation of the rotational movement of the steering wheel is raised, the processor 110 switches to the driver steering mode according to the raised reference.

For example, when the commanded steering angle velocity instantaneously reaches or exceeds 1.5 rotations per second (rps) based on an angle of the steering wheel, the processor 110 may greatly increase the column torque and may change the time taken to switch from the motor position steering angle signal to the steering angle signal of the steering angle sensor 142 of the steering wheel (MPS SAS) from 2 seconds to 3 seconds.

The processor 110 adds the time required for torque to occur in response to an unintended increase in torque. Then, based on an amount of torque that occurs when the driver actually operates the steering wheel, the processor 110 changes the steering angle signal (MPS→SAS).

The steering angle sensor 142 may be installed in the steering wheel and may generate the motor position steering angle signal through a column and a rack bar. As a result, a difference in an angle between the motor position steering angle signal (MPS) and the steering angle signal SAS of the steering angle sensor 142 of the steering wheel occurs to the degree to which the torsion bar is twisted.

For this reason, a difference occurs between signal values of the motor-angle sensor 141 and the steering angle sensor 142. When the final feedback signal is changed from the motor position steering angle signal computed from the motor-angle sensor 141 to the steering angle signal of the steering angle sensor 142, an error that results from control of the MDPS apparatus 150 instantaneously occurs to a great degree. Thus, a situation where the MDPS apparatus 150 cannot be controlled may occur.

Accordingly, the processor 110 generates the final feedback signal. However, in a process of changing the motor position steering angle signal to the steering angle of the steering angle sensor 142, the processor 110 changes the reference steering angle signal by adjusting a reflection ratio step by step within a designated time.

The processor 110 changes the reference steering angle signal step by step using a ramp-up technique.

For example, the processor 110 changes a steering angle represented by the final feedback signal using the following Equation 1.

STEERING ANGLE=K*MPS+(1−K)*SAS Equation 1

In Equation 1, K is a constant for determining the reflection ratio with respect to the steering angle signal, MPS is a first steering angle signal that is the motor position steering angle signal, and SAS is a second steering angle signal that is the steering angle signal of the steering angle sensor.

The processor 110 changes the steering angle signal by adjusting constant K step by step. When K is 1, the motor position steering angle signal is reflected by 100%. When K is 0, the steering angle signal of the steering angle sensor 142 is reflected by 100%.

The processor 110 changes K from 1 to 0 step by step within a preset time. That is, the processor 110 changes the reference steering angle signal from the motor position steering angle signal to the steering angle signal of the steering angle sensor 142 and generates the final feedback signal using both the steering angle signals for the preset time.

In a situation where the drive is unintendedly involved in steering the steering wheel during the autonomous traveling, the processor 110 keeps the vehicle traveling in the autonomous traveling mode.

When the driver unintendedly steers the steering wheel, the degree to which the torsion bar is twisted is fed back to the processor 110 through the steering angle signal of the steering angle sensor 142, and the processor 110 compensates for the steering angle by reflecting the fed-back degree through the final feedback signal.

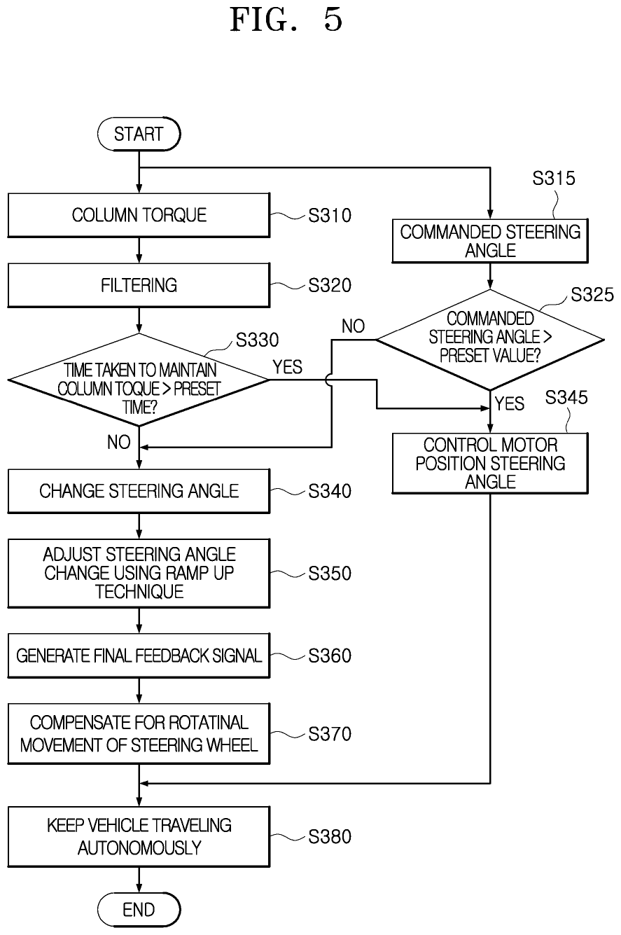

FIG. 5 is a flowchart illustrating a method of controlling the vehicle steering control apparatus according to a second embodiment of the present disclosure.

As illustrated in FIG. 5, when the steering wheel is rotationally moved during the autonomous traveling, the rotational movement of the steering wheel causes the torsion bar to be twisted, and thus the column torque (S310).

The processor 110 filters the column torque (S320), and removes such a small rotational movement of the steering that it does not have an influence on the autonomous traveling control. The processor 110 filters the column torque using at least one of the notch filter, the band-stop filter, and the lead-lag filter.

The processor 110 counts the time taken to maintain the column torque and determines whether or not the time taken to maintain the column torque reaches or exceeds a preset time (S330).

In addition, the processor 110 receives the commanded steering angle of the autonomous traveling controller 160, as an input (S315), and checks the commanded steering angle. The processor 110 compares a magnitude of the commanded steering angle with a preset value (S325).

When the time taken to maintain the column torque exceeds the preset time and the commanded steering angle exceeds the preset value, the processor 110 changes the reference steering angle signal for controlling the MDPS apparatus 150 (S340).

When the column torque changes temporarily and the commanded steering angle reaches or falls short of the preset value, the processor 110 controls the MDPS apparatus 150 on the basis of the first steering angle signal that is the motor position steering angle signal computed on the basis of the motor angle of the motor-angle sensor 141 (S345).

When the steering wheel is rotationally moved during the autonomous traveling, the column torque occurs according to the degree of the rotational movement of the steering wheel, that is, the degree to which the torsion bar is twisted. When the steering wheel is abruptly rotationally moved, a magnitude of the column torque increases. Correspondingly, the autonomous traveling controller 160 computes the commanded steering angle.

Accordingly, the processor 110 determines the degree of the rotational movement of the steering wheel, in a manner that corresponds to both the time taken to maintain the column torque and the magnitude of the commanded steering angle, and then changes the steering angle signal for the MDPS apparatus 150.

During the autonomous traveling, the processor 110 generates the feedback signal on the basis of the motor position steering angle signal computed from the motor angle of the motor-angle sensor 141 and applies the generated feedback signal to the position controller 170, and the position controller 170 controls the MDPS apparatus 150 on the basis of the commanded steering angle and the feedback signal.

When the steering wheel is abruptly rotationally moved during the autonomous traveling, the processor 110 changes the reference steering angle signal from the motor position steering angle signal to the steering angle signal the second steering angle signal) of the steering angle sensor 142.

In a state where the steering wheel is rotationally moved, a difference in the steering angle occurs between the motor-angle sensor 141 and the steering angle sensor 142. The processor 110 adjusts a change in the steering angle using the ramp-up technique (S350).

When the reference steering angle signal is changed, the processor 110 changes the reference steering angle signal by changing the reflection rate step by step as expressed in Equation 1, instead of immediately changing the reference steering angle signal from the steering angle signal (the first steering angle signal) of the motor-angle sensor 141 and the steering angle signal (the second steering angle signal) of the steering angle sensor 142.

The processor 110 generates the final feedback signal in which the rotational movement of the steering wheel is reflected, on the basis of the steering angle signal (the second steering angle signal) of the steering angle sensor 142 (S360), and applies the generated final feedback signal to the position controller 170 and the autonomous traveling controller 160.

The processor 110 keeps the vehicle traveling autonomously (S380) and compensates for the rotational movement of the steering wheel (S370).

When the steering wheel is not rotationally moved while the vehicle is kept traveling autonomously, the processor 110 changes the reference steering angle signal for controlling the MDPS apparatus 150 and then reperforms motor position steering angle control.

When the steering wheel continues to be rotationally moved by the driver's steering, the processor 110 deactivates the autonomous traveling mode and switches to the driver steering mode.

During the autonomous traveling, the driver may be involved in steering the steering wheel, and thus the steering wheel may be abruptly rotationally moved. In this case, in the vehicle steering control apparatus and the method of controlling the vehicle steering control apparatus according to the first and second embodiments, respectively, of the present disclosure, the MDPS apparatus 150 is controlled by reflecting the rotational movement of the steering wheel, while the vehicle is kept traveling in the autonomous traveling mode without the need to deactivate it. Thus, the safety during the autonomous traveling can be improved.

What is claimed is:

1. A vehicle steering control apparatus comprising:
a steering apparatus configured to control a traveling direction of a vehicle;
an autonomous traveling controller configured to compute a commanded steering angle for controlling the traveling direction of the vehicle in an autonomous traveling mode;
a position controller configured to control the steering apparatus in response to the commanded steering angle;
a motor-angle sensor installed in the steering apparatus and configured to measure a motor angle;
a steering angle sensor installed in a steering wheel and configured to measure a steering angle that corresponds to a rotational movement of the steering wheel; and
a processor configured to set a reference steering angle signal in such a manner as to control the steering apparatus on the basis of one of a first steering angle signal computed from the motor angle and a second steering angle of the steering angle sensor, in a manner that corresponds to an autonomous traveling mode of the vehicle, to generate a feedback signal on a control error on the basis of the reference steering angle signal, and to apply the generated feedback signal to the autonomous traveling controller,
wherein the processor changes the reference steering angle signal to the second steering angle when the rotational movement of the steering wheel is detected in the autonomous traveling mode.

2. The vehicle steering control apparatus of claim 1, wherein when the rotational movement of the steering wheel is detected in the autonomous traveling mode, the processor keeps the vehicle traveling in the autonomous traveling mode for a predetermined time and compensates for the rotational movement of the steering wheel through the feedback signal.

3. The vehicle steering control apparatus of claim 1, wherein when a time taken to maintain a column torque due to the rotational movement of the steering wheel exceeds a preset time and a magnitude of the commanded steering angle that changes due to the rotational movement of the steering wheel exceeds a preset value, the processor changes the reference steering angle signal to the second steering angle signal.

4. The vehicle steering control apparatus of claim 3, wherein the processor removes a resonance point of the column torque by filtering the column torque through one of a notch filter, a band-stop filter, and a lead-lag filter.

5. The vehicle steering control apparatus of claim 1, wherein when a time taken to maintain a column torque due to the rotational movement of the steering wheel reaches or falls short of a preset time, or when a magnitude of the commanded steering angle that changes due to the rotational movement of the steering wheel reaches or falls short of a preset value, the processor maintains the reference steering angle signal as the first steering angle signal.

6. The vehicle steering control apparatus of claim 1, wherein the processor changes the reference steering angle signal by adjusting a reflection ratio step by step within a designated time.

7. The vehicle steering control apparatus of claim 1, wherein when the rotational movement of the steering wheel is detected in the autonomous traveling mode, the processor keeps the vehicle traveling in the autonomous traveling mode by changing a condition for deactivating the autonomous traveling mode.

8. The vehicle steering control apparatus of claim 1, wherein either when the rotational movement of the steering wheel satisfies a changed condition or when the steering wheel continues to be rotationally moved by a driver's steering, the processor deactivates the autonomous traveling mode and switches to a driver steering mode.

9. A method of controlling a vehicle steering control apparatus, the method comprising:
setting, by a processor, a reference steering angle signal in such a manner that a steering apparatus is controlled on the basis of one of a first steering angle signal computed from a motor angle of a motor-angle sensor and a second steering angle signal of a steering angle sensor, in a manner that corresponds to an autonomous traveling mode of a vehicle;
computing, by an autonomous traveling controller, a commanded steering angle for controlling a traveling direction of the vehicle and controlling, by a position controller, the steering apparatus in a manner that corresponds to the commanded steering angle, in the autonomous traveling mode;
generating, by the processor, a feedback signal on a control error on the basis of the first steering angle signal and applying, by the processor, the generated feedback signal to the position controller and the autonomous traveling controller;
changing, by the processor, the reference steering angle signal to the second steering angle signal in response to a rotational movement of a steering wheel being detected in the autonomous traveling mode; and
generating, by the processor, the feedback signal on the basis of the second steering angle signal and applying the generated feedback signal to the position controller and the autonomous traveling controller.

10. The method of claim 9, further comprising, in response to the rotational movement of the steering wheel being detected in the autonomous traveling mode, keeping, by the processor, the vehicle traveling in the autonomous traveling mode for a predetermined time, and compensating for, by the processor, the rotational movement of the steering wheel through the feedback signal.

11. The method of claim 9, wherein the changing of the reference steering angle signal to the second steering angle signal comprises:
counting, by the processor, a time taken to maintain column torque due to the rotational movement of the steering wheel and comparing the counted time taken to maintain the column torque with a preset time;
comparing, by the processor, a magnitude of the commanded steering angle that changes due to the rotational movement of the steering wheel with a preset value; and
changing, by the processor, the reference steering angle signal to the second steering angle signal in response to the time taken to maintain the column torque exceeding the preset time and the magnitude of the commanded steering angle exceeds the preset value.

12. The method of claim 11, wherein the changing of the reference steering angle signal to the second steering angle signal further comprises:
removing, by the processor, a resonance point of the column torque by filtering the column torque through one of a notch filter, a band-stop filter, and a lead-drag filter.

13. The method of claim 9, further comprising:
maintaining, by the processor, the reference steering angle signal as the first steering angle signal in response to a time taken to maintain column torque due to the rotational movement of the steering wheel reaching or falling short of a preset time or in response to a magnitude of the commanded steering angle that changes due to the rotational movement of the steering wheel reaching or falling short of a preset value, in response to the rotational movement of the steering wheel being detected in the autonomous traveling mode.

14. The method of claim 13, wherein the changing of the reference steering angle signal to the second steering angle signal includes changing, by the processor, the reference steering angle signal from the first steering angle signal to the second steering angle signal by adjusting a reflection ratio step by step within a designated time.

15. The method of claim 9, further comprising:
keeping, by the processor, the vehicle traveling in the autonomous traveling mode by changing a condition for deactivating the autonomous traveling mode, in response to the rotational movement of the steering wheel being detected in the autonomous traveling mode; and
deactivating, by the processor, the autonomous traveling mode and switching to a driver steering mode either in response to the rotational movement of the steering wheel satisfying a changed condition or in response to the steering wheel continuing to be rotationally moved by a driver's steering.
